(19) United States
(12) Patent Application Publication
(10) Pub. No.: US 2007/0052652 A1
(43) Pub. Date: Mar. 8, 2007

(54) Liquid crystal display and pre-charge driving method thereof

(75) Inventors: Juhn Suk Yoo, Seoul (KR); Bu Yeol Lee, Seoul (KR)

Correspondence Address: MCKENNA LONG & ALDRIDGE LLP, 1900 K STREET, NW, WASHINGTON, DC, 20006, US

(73) Assignee: LG.PHILIPS LCD CO., LTD., Seoul (KR)

(21) Appl. No.: 11/511,510

(22) Filed: Aug. 29, 2006

(30) Foreign Application Priority Data
Aug. 29, 2005 (KR) 10-2005-0079290

(51) Int. Cl. G09G 3/36

(52) U.S. Cl. 345/98

(57) ABSTRACT

There are provided a liquid crystal display and a pre-charge driving method thereof. The liquid crystal display includes a liquid crystal panel; a gate driver; a data driver; a pre-charge driver that sequentially transfers pre-charge signals to each of data lines by data enable signals before data signals are transferred to each of the data lines; and a timing controller. The pre-charge driving method of a liquid crystal display comprises sequentially supplying scan signals to each of a plurality of gate lines; sequentially transferring pre-charge signals to each of a plurality of data lines by data enable signals; and sequentially transferring data signals to each of the data lines by the data enable signals after the pre-charge signals are transferred to each of the data lines.

This application claims the benefit of Korean Application No. 10-2006-0079290 filed on Aug. 29, 2005, the entire contents of which are hereby incorporated by reference for all purposes as if fully set forth herein.

### BACKGROUND OF THE INVENTION

1. Field of the Invention

A liquid crystal display (LCD) and a pre-charge driving method thereof are provided.

2. Discussion of the Related Art

In the liquid crystal display, a liquid crystal material having dielectric anisotropy is injected between a color filter substrate and an array substrate, where the color filter substrate is an upper transparent insulating substrate and the array substrate is a lower transparent insulating substrate. Accordingly, molecular arrangement of the liquid crystal material is changed by adjusting intensity of an electric field that is formed in the liquid crystal material, whereby an amount of light transmitted to the transparent insulating substrate is adjusted, so that a desired image is displayed.

As the liquid crystal display, a thin film transistor liquid crystal display (TFT LCD) using a thin film transistor (TFT) as a switching element has been mainly used.

In general, a liquid crystal display comprises a liquid crystal panel that displays an image and a driver that is positioned at the outside of the liquid crystal panel to drive the liquid crystal panel. The driver comprises a data driver and a gate driver for driving the liquid crystal panel, a timing controller for controlling a driving timing of the data driver and the gate driver.

Referring to FIGS. 1 and 2, a liquid crystal display in the related art will be described.

FIG. 1 is a view illustrating a construction of a liquid crystal display in the related art. FIG. 2 is a timing chart of signals that are supplied to the liquid crystal display of FIG. 1.

The liquid crystal display in the related art comprises a liquid crystal panel 10, a gate driver 11, a data driver 12, a pre-charge driver 14, a timing controller 13, etc. The gate driver 11 sequentially supplies scan signals to each of gate lines (GL1, GL2, . . . , GLn) and the data driver 12 sequentially supplies data enable signals DE1 to DEm using shift registers S/R1 to S/Rm and sequentially transfers data signals d1 to dm to data lines (DL1, DL2, . . . , DLm) through switching elements T1 to Tm by the data enable signals DE1 to DEm during one horizontal period 1H.

After the data signals d1 to dm are transferred to the data lines (DL1, DL2, . . . , DLm) during each one horizontal period 1H, the pre-charge driver 14 simultaneously transfers a pre-charge voltage Vpre to all data lines (DL1, DL2, . . . , DLm) using switching elements S1 to Sm by a pre-charge enable signal pre_en, thereby simultaneously pre-charging the data lines (DL1, DL2, . . . , DLm).

According to a pre-charge driving method of the liquid crystal display, since the pre-charge driver 14 simultaneously pre-charges all data lines (DL1, DL2, . . . , DLm), a driving burden of the pre-charge driver 14 is increased and a distortion phenomenon of a liquid crystal voltage that is stored in a liquid crystal capacitor Clc is caused by coupling of the data lines (DL1, DL2, . . . , DLm) and a pixel electrode of a TFT, thereby deteriorating image quality.

Referring to FIGS. 3 and 4, a liquid crystal display in the other related art will be described. FIG. 3 is a view illustrating a construction of a liquid crystal display in the other related art. FIG. 4 is a timing chart of signals that are supplied to the liquid crystal display of FIG. 3.

The liquid crystal display in the other related art comprises a liquid crystal panel 20, a gate driver 21, a data driver 22, a timing controller 23, etc. The gate driver 21 sequentially supplies scan signals to each of the gate lines (GL1, GL2, . . . , GLn) and the data driver 22 sequentially supplies data enable signals DE1 to DEm using shift registers S/R1 to S/Rm and sequentially transfers the data signals d1 to dm to the data lines (DL1, DL2, . . . , DLm) through the switching elements T1 to Tm by the data enable signals DE1 to DEm during one horizontal period 1H.

Here, the data driver 22 pre-charges the data signal d1 to the data line DL2 by transferring the data signal d1 to two data lines (e.g., DL1 and DL2) during a predetermined time.

In a pre-charge driving method of a liquid crystal display, since the data driver 22 simultaneously transfers a data signal to two data lines, a driving burden of the data driver 22 increases.

### SUMMARY OF THE INVENTION

Accordingly, an object of the present invention is to solve at least the problems and disadvantages of the related art.

An advantage of the present invention is to provide a liquid crystal display and a pre-charge driving method thereof that can reduce a driving burden of a pre-charge driver or a data driver without deteriorating image quality by sequentially pre-charging each of the data lines using data enable signals of the data driver without a separate pre-charge control signal.

The present invention is not limited to the above-described advantage other advantages may be understood by those skilled in the art from the following description.

According to an aspect of the present invention, there is provided a liquid crystal display comprising: a liquid crystal panel including a plurality of pixels divided into a plurality of gate lines and a plurality of data lines crossing each other and that displays an image in each pixel depending on scan signals transferred through the plurality of gate lines and data signals transferred through the plurality of data lines; a gate driver that sequentially supplies the scan signals to each of the plurality of gate lines; a data driver that sequentially transfers the data signals to each of the plurality of data lines by data enable signals; a pre-charge driver that sequentially transfers pre-charge signals to each of the data lines by the data enable signals before the data signals are transferred to each of the data lines; and a timing controller that supplies a timing control signal to the gate driver and the data driver, supplies the data signals to the data driver, and supplies the pre-charge signals to the pre-charge driver.

According to another aspect of the present invention, there is provided a pre-charge driving method of a liquid crystal display comprising: sequentially supplying scan signals to each of a plurality of gate lines; sequentially transferring pre-charge signals to each of a plurality of data lines by data enable signals; and sequentially transferring the data signals to each of the data lines by the data enable signals after the pre-charge signals are transferred to each of the data lines.

It is to be understood that both the foregoing general description and the following detailed description are exemplary and explanatory and are intended to provide further explanation of the invention as claimed.

### BRIEF DESCRIPTION OF THE DRAWINGS

The invention will be described in detail with reference to the following drawings in which like numerals refer to like elements.

FIG. 1 is a view illustrating a construction of a liquid crystal display in the related art;

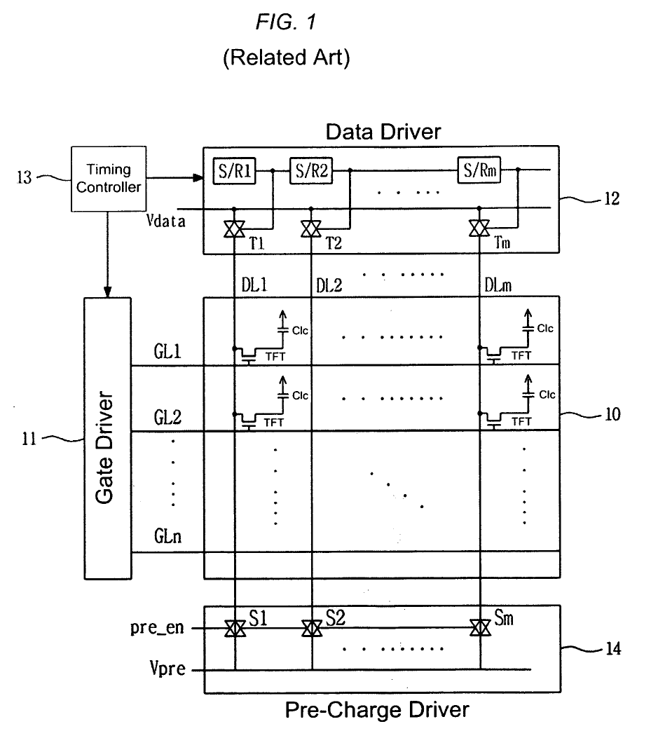

FIG. 2 is a timing chart of signals that are supplied to the liquid crystal display of FIG. 1;

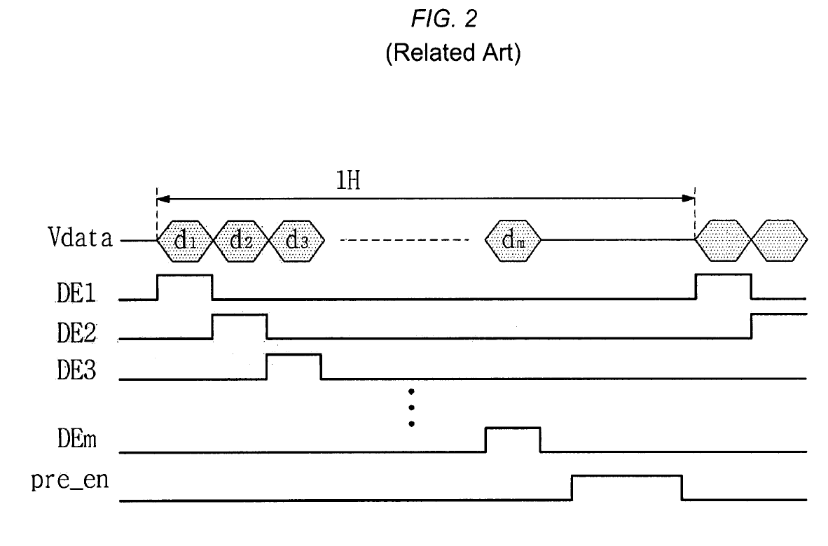

FIG. 3 is a view illustrating a construction of a liquid crystal display in the other related art;

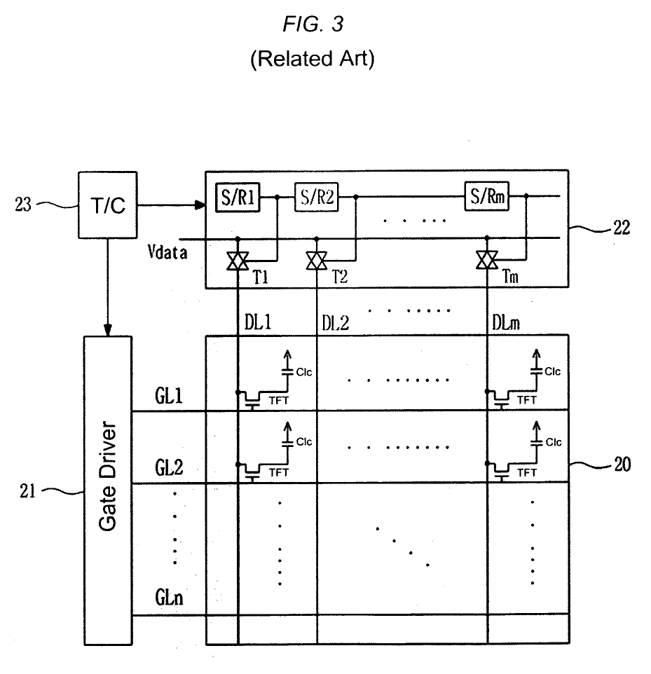

FIG. 4 is a timing chart of signals that are supplied to the liquid crystal display of FIG. 3;

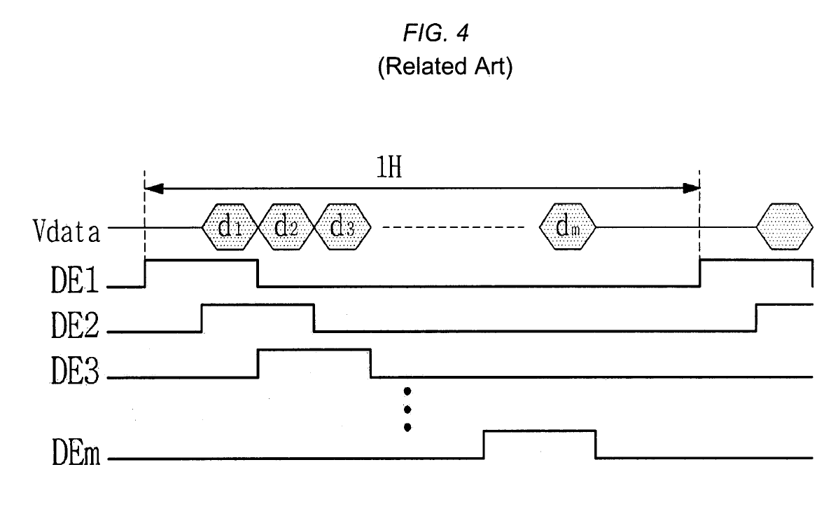

FIG. 5 is a view illustrating a construction of a liquid crystal display according to an embodiment of the present invention; and

FIG. 6 is a timing chart of signals that are supplied to the liquid crystal display of FIG. 5.

### DETAILED DESCRIPTION OF THE ILLUSTRATED EMBODIMENTS

Hereinafter, a liquid crystal display and a pre-charge driving method thereof according to an embodiment of the present invention will be described in detail.

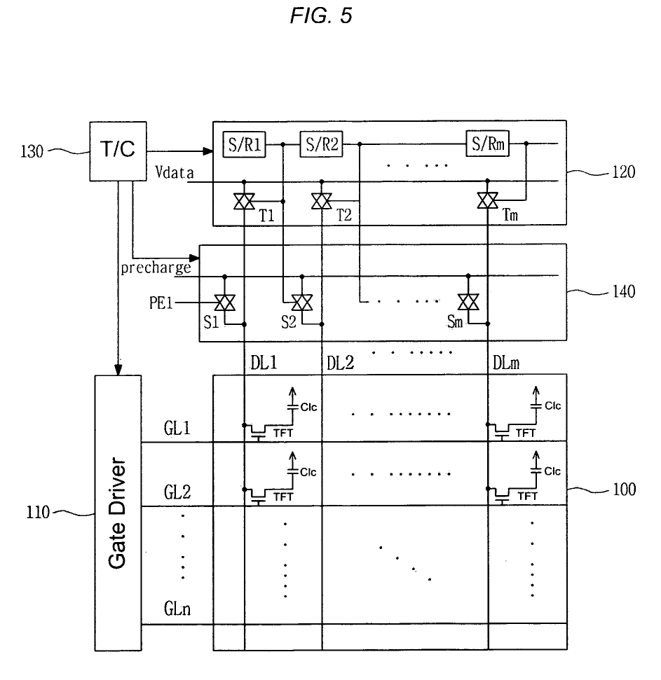

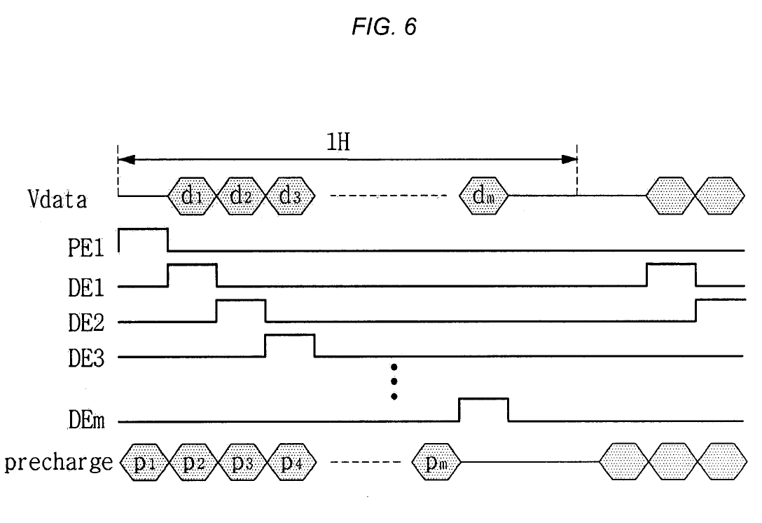

FIG. 5 is a view illustrating a construction of a liquid crystal display according to an embodiment of the present invention and FIG. 6 is a timing chart of signals that are supplied to the liquid crystal display of FIG. 5.

The liquid crystal display according to an embodiment of the present invention comprises a liquid crystal panel 100, a gate driver 110, a data driver 120, a timing controller 130, a pre-charge driver 140, etc.

The liquid crystal panel 100 comprises a plurality of pixels that are divided into gate lines (GL1, GL2, . . . , GLn) and data lines (DL1, DL2, . . . , DLm) crossing each other. A TFT comprising a gate electrode, a pixel electrode, a source electrode, and a drain electrode is disposed at crossings of the gate lines (GL1, GL2, . . . , GLn) and the data lines (DL1, DL2, . . . , DLm) and a liquid crystal material of an amount corresponding to capacitance of pixels is filled in the pixels. The liquid crystal panel 100 displays an image in each pixel depending on a scan signal that is supplied through the gate lines (GL1, GL2, . . . , GLn) and data signals d1 to dm that are transferred through the data lines (DL1, DL2, . . . , DLm).

The gate driver 110 sequentially supplies a scan signal to the gate lines (GL1, GL2, . . . , GLn) in response to a timing control signal.

The data driver 120 sequentially supplies data enable signals DE1 to DEm using shift registers S/R1 to S/Rm in response to a timing control signal and transfers the data signals d1 to dm that are input from the timing controller 130 to the data lines (DL1, DL2, . . . , DLm) through the m number of switching elements T1 to Tm by the data enable signals DE1 to DEm during one horizontal period 1H. Here, the m number of switching elements T1 to Tm can be easily composed using the m number of transmission gates.

The pre-charge driver 140 sequentially transfers pre-charge signals p1 to pm to each of the data lines (DL1, DL2, . . . , DLm) during one horizontal period 1H through the m number of switching elements S1 to Sm by the data enable signals DE1 to DEm before the data signals d1 to dm are transferred to each of the data lines (DL1, DL2, . . . , DLm). Here, the m number of switching elements S1 to Sm can be easily composed using the m number of transmission gates.

The timing controller 130 controls drive timing by supplying a timing control signal to the gate driver 110 and the data driver 120, supplies the data signals d1 to dm to the data driver 120, and supplies the pre-charge signals p1 to pm to the pre-charge driver 140.

Here, the data enable signals DE1 to DEm comprise the first to m-th data enable signals and a plurality of data lines (DL1, DL2, . . . , DLm) comprises the first to m-th data lines.

The data driver 120 transfers a data signal to a k-th data line by a k-th data enable signal (where k is 1≦k≦m). That is, the data driver 120 transfers the data signal d1 to the first data line DL1 by the first data enable signal DE1 and transfers the data signal dm to a m-th data line DLm by the m-th data enable signal DEm.

The pre-charge driver 140 transfers a pre-charge signal to a (j+1)th data line by a j-th data enable signal (where j is 1≦j≦m−1). That is, the pre-charge driver 140 transfers the pre-charge signal p2 to the second data line DL2 by the first data enable signal DE1 and transfers a pre-charge signal pm by the (m−1)th data enable signal DEm−1 to the m-th data line DLm.

Therefore, the data driver 120 transfers the data signal d1 to the first data line DL1 through the switching element T1 by the first data enable signal DE1 and the pre-charge driver 140 transfers the pre-charge signal p2 before the data signal d2 is transferred to the second data line DL2 through the switching element S2 by the first data enable signal DE1.

Furthermore, the data driver 120 transfers the data signal d2 to the second data line DL2 through the switching element T2 by the second data enable signal DE2 after the pre-charge signal p2 is transferred to the second data line DL2 and the pre-charge driver 140 transfers the pre-charge signal p3 before the data signal d3 is transferred to the third data line DL3 through the switching element S3 by the second data enable signal DE2.

The pre-charge driver 140 transfers the pre-charge signal p1 before the data signal d1 is transferred to the first data line DL1 through the switching element S1 by a first pre-charge enable signal PE1. Here, the first pre-charge enable signal PE1 is supplied from the timing controller 130.

When the liquid crystal panel 100, the data driver 120, and the pre-charge driver 140 are made of poly-silicon, they may be integrally formed. Accordingly, the liquid crystal display can be further decreased in size and thickness.

Unlike the liquid crystal display in the related art, in a liquid crystal display and a pre-charge driving method thereof according to an embodiment of the present invention, as the pre-charge driver 140 sequentially pre-charges each of the data lines (DL1, DL2, . . . , DLm) using the data enable signals DE1 to DEm of the data driver 120, it is possible to effectively prevent image quality from deteriorating by coupling the data lines (DL1, DL2, . . . , DLm) and a pixel electrode of the TFT even while effectively reducing a driving burden of the pre-charge driver 140.

Furthermore, unlike the liquid crystal display in the other related art, in the liquid crystal display and the pre-charge driving method thereof according to an embodiment of the present invention, as the pre-charge driver 140 sequentially pre-charges each of the data lines (DL1, DL2, . . . , DLm) using the data enable signals DE1 to DEm of the data driver 120, the data driver 120 can sequentially transfer a data signal to one data line, so that a driving burden of the data driver 120 can be effectively reduced.

Unlike the liquid crystal display in the related art, in the liquid crystal display and the pre-charge driving method thereof according to an embodiment of the present invention having the above-described construction, as the pre-charge driver sequentially pre-charges each of the data lines using the data enable signals of the data driver, it is possible to effectively prevent image quality from deteriorating by coupling of the data lines and a pixel electrode of the TFT even while effectively reducing a driving burden of the pre-charge driver.

Furthermore, unlike the liquid crystal display in the other related art, in the liquid crystal display and the pre-charge driving method thereof according to an embodiment of the present invention, as the pre-charge driver sequentially pre-charges each of the data lines using the data enable signals of the data driver, the data driver 120 can sequentially transfer a data signal to one data line, so that a driving burden of the data driver can be effectively reduced.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display comprising:
a liquid crystal panel including a plurality of pixels divided by a plurality of gate lines and a plurality of data lines crossing each other; wherein an image is displayed in each pixel depending on scan signals transferred through the plurality of gate lines and data signals transferred through the plurality of data lines;
a gate driver that sequentially supplies the scan signals to each of the plurality of gate lines;
a data driver that sequentially transfers the data signals to each of the plurality of data lines by data enable signals;
a pre-charge driver that sequentially transfers pre-charge signals to each of the data lines by data enable signals before the data signals are transferred to each of the data lines; and
a timing controller that supplies a timing control signal to the gate driver and the data driver, supplies the data signals to the data driver, and supplies the pre-charge signals to the pre-charge driver.

2. The liquid crystal display of claim 1, wherein the pre-charge driver transfers the pre-charge signal to the data line by the pre-charge enable signal.

3. The liquid crystal display of claim 2, wherein the pre-charge driver comprises a plurality of switching elements each transferring the pre-charge signal to the data line.

4. The liquid crystal display of claim 3, wherein the plurality of switching elements is a transmission gate.

5. The liquid crystal display of claim 1, wherein the data enable signals comprise first to m-th data enable signals and the plurality of data lines comprise first to m-th data lines; and
the data driver transfers the data signal to a k-th data line by a k-th data enable signal (1≦k≦m) and the pre-charge driver transfers the pre-charge signal to a (j+1)th data line by a j-th data enable signal (1≦j≦m−1).

6. The liquid crystal display of claim 5, wherein the pre-charge driver transfers the pre-charge signal to the first data line by the first pre-charge enable signal.

7. The liquid crystal display of claim 6, wherein the pre-charge driver comprises the m number of switching elements for transferring the pre-charge signal to the first to m-th data lines.

8. The liquid crystal display of claim 7, wherein the m number of switching elements are transmission gates.

9. The liquid crystal display of claim 1, wherein the liquid crystal panel, the data driver, and the pre-charge driver are integrally formed.

10. A pre-charge driving method of a liquid crystal display comprising:
sequentially supplying scan signals to each of a plurality of gate lines;
sequentially transferring pre-charge signals to each of a plurality of data lines by data enable signals; and
sequentially transferring data signals to each of the data lines by the data enable signals after the pre-charge signals are transferred to each of the data lines.

11. The pre-charge driving method of claim 10, wherein the data enable signals comprise first to m-th data enable signals and the plurality of data lines comprise first to m-th data lines;
the transferring of the pre-charge signals is to transfer the pre-charge signal to a (j+1)th data line by a j-th data enable signal (1<j<m−1); and
the transferring of the data signal is to transfer the data signal to a k-th data line by a k-th data enable signal (1≦k≦m).

12. The pre-charge driving method of claim 11, wherein the transferring of the pre-charge signal is to transfer the pre-charge signal to the first data line by the first pre-charge enable signal.
